(19) United States
(12) Patent Application Publication
(10) Pub. No.: US 2022/0250322 A1
(43) Pub. Date: Aug. 11, 2022

(54) AUTOMATED PELLET DRYING AND DISPENSING SYSTEM FOR ADDITIVE MANUFACTURING

(71) Applicant: General Electric Company, Schenectady, NY (US)

(72) Inventors: James Robert Tobin, Greenville, SC (US); Andrew McCalip, Houston, TX (US)

(21) Appl. No.: 17/629,977

(22) PCT Filed: Jul. 26, 2019
(86) PCT No.: PCT/US2019/043685

§ 371 Date: Jan. 25, 2022

(51) Int. Cl. B29C 64/314; B33Y 10/00; B33Y 30/00; B33Y 50/02; B29C 64/118; B29B 13/06; B29C 64/393; B33Y 40/10; B29C 64/329

(52) U.S. Cl. CPC B29C 64/314; B33Y 10/00; B33Y 30/00; B33Y 50/02; B29C 64/329; B29B 13/065; B29C 64/393; B33Y 40/10; B29C 64/118

(57) ABSTRACT

A system for forming an article includes at least one print head assembly comprising a printer head, a printer nozzle, and at least one hopper. The system also includes a drying assembly having at least one dryer and a dispenser. The dryer is for drying a plurality of polymer pellets of one or more polymer resin formulations. The dispenser is positioned above and separate from the print head assembly for dispensing the dried plurality of pellets directly from the drying assembly and into the hopper of the print head assembly before or during printing. Further, the printer head is configured to melt the dried plurality of polymer pellets. The printer nozzle is configured for depositing and printing the melted plurality of polymer pellets onto a substrate to form the article. The system also includes a controller for controlling and automating the system.

### FIELD

The present disclosure relates in general to additive manufacturing, and more particularly to systems and methods for drying and dispensing dried pellets into one or more hoppers before or during printing to improve additive manufacturing processes.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The rotor blades generally include a suction side shell and a pressure side shell typically formed using molding processes that are bonded together at bond lines along the leading and trailing edges of the blade. Further, the pressure and suction shells are relatively lightweight and have structural properties (e.g., stiffness, buckling resistance and strength) which are not configured to withstand the bending moments and other loads exerted on the rotor blade during operation. Thus, to increase the stiffness, buckling resistance and strength of the rotor blade, the body shell is typically reinforced using one or more exterior structural components (e.g. opposing spar caps with a shear web configured therebetween) that engage the inner pressure and suction side surfaces of the shell halves.

The spar caps are typically constructed of various materials, including but not limited to glass fiber laminate composites and/or carbon fiber laminate composites. The shell of the rotor blade is generally built around the spar caps of the blade by stacking layers of fiber fabrics in a shell mold. The layers are then typically infused together with a resin.

With the increase in popularity of additive manufacturing, however, it would be desirable to manufacture some of the various wind turbine components using such techniques. Although, certain considerations must be taken into account when manufacturing wind turbine components, such as adhesion, loading, stiffness, strength, etc.

For example, there is a need to dry out plastic pellets before loading the pellets into the 3-D printer as drying the pellets and eliminating water therefrom results in better printed properties, including adhesion and strength in various directions. For conventional 3-D printing applications, the pellets are dried in a separate dryer and then transported to the 3-D printer for subsequent printing. More specifically, the pellets are loaded into a hopper before the printing process begins. As the pellets sit in the hopper, however, they absorb water as a function of time despite being dried out beforehand.

This issue is magnified when using 3-D printers with multiple hoppers to fill as the feasibility of dispensing dried pellets (that remain dry) into a multitude of hoppers through conventional means is problematic. In addition, conventional dryers are heavy and difficult to move.

In view of the foregoing, the present disclosure is directed to improved systems and methods for dispensing the dried pellets into one or more hoppers before or during printing to address the aforementioned issues.

### BRIEF DESCRIPTION

Aspects and advantages of the invention will be set forth in part in the following description, or may be obvious from the description, or may be learned through practice of the invention.

In one aspect, the present disclosure is directed to a system for forming an article. The system includes at least one print head assembly comprising a printer head, a printer nozzle, and at least one hopper. The system also includes a drying assembly having at least one dryer and at least one dispenser. The dryer(s) is for drying a plurality of polymer pellets of one or more polymer resin formulations. The dispenser(s) is positioned above and separate from the print head assembly for dispensing the dried plurality of pellets directly from the drying assembly and into the hopper of the print head assembly before or during printing. Further, the printer head is configured to melt the dried plurality of polymer pellets. The printer nozzle is configured for depositing and printing the melted plurality of polymer pellets onto a substrate to form the article. The system also includes a controller for controlling and automating the system.

In an embodiment, the system may also include one or more measuring devices communicatively coupled to the controller. As such, the measuring device(s) may be used for measuring an amount of the dried plurality of pellets dispensed by the dispenser or an amount of the dried plurality of pellets remaining in the hopper. For example, in one embodiment, the measuring device may be a sensor (such as flow meter) or a measuring marker on the hopper.

In another embodiment, the controller can monitor the amount of the dried plurality of pellets remaining in the hopper, e.g. using measurement signals from the measuring device, and a duration of time that the dried plurality of pellets have remained in the hopper and can command the dispenser when to dispense more of the dried plurality of pellets to the hopper.

In yet another embodiment, the controller may also monitor the amount of the dried plurality of pellets remaining in the hopper and if the amount is not reducing during printing (e.g. due to a clogged system), the controller can implement a corrective action. For example, in certain embodiments, the corrective action may include generating an error signal, stopping or pausing the depositing and printing, and/or agitating the dried plurality of pellets remaining in the hopper.

In further embodiments, the dispenser may include valve, a hose, or any other suitable dispenser configured to manually or automatically dispense the dried plurality of pellets into the hopper based on the amount of the dried plurality of pellets remaining in the hopper, the amount of the dried plurality of pellets dispensed by the dispenser, and/or the amount of the dried plurality of pellets required to form the article.

In another embodiment, the system may include a plurality of print head assemblies. In such embodiments, the dispenser may be configured to separately dispense the dried plurality of pellets directly into a plurality of hoppers of the plurality of print head assemblies.

In addition, in an embodiment, the dispenser of the drying assembly may be stationary and the plurality of hoppers of the plurality of print head assemblies may be movable, e.g. via a moveable gantry secured to a rail system, so as to fill the plurality of hoppers via the dispenser. Alternatively, the dispenser may be moveable and the plurality of hoppers of the plurality of print head assemblies may be stationary.

In another aspect, the present disclosure is directed to a method of forming an article. The method includes drying, via at least one dryer of a drying assembly, a plurality of polymer pellets of one or more polymer resin formulations. The method also includes dispensing, via a dispenser of the drying assembly, the dried plurality of pellets directly into at least one hopper of at least one print head assembly before or during printing. Further, the dispenser is positioned above and separate from the hopper(s). Moreover, the method includes melting, via a printer head of at least one print head assembly, the dried plurality of polymer pellets. In addition, the method includes printing and depositing, via a printer nozzle of at least one print head assembly, the melted plurality of polymer pellets layer by layer to form the article.

In an embodiment, the method may include determining an amount of the plurality of polymer pellets required to build the article and providing the amount to the at least one hopper via the dispenser. For example, in an embodiment, determining the amount of the plurality of polymer pellets required to build the article may include providing an additional margin of the dried plurality of polymer pellets above what is required to build the article.

In further embodiments, the plurality of polymer pellets may include, at least, a first composition of polymer pellets in a first dryer and a different, second composition of polymer pellets in a second dryer. Further, the first and second compositions of polymer pellets each include one or more polymer types and/or compositions or combinations thereof. Thus, an in an embodiment, the method may include providing the first composition of polymer pellets from the first dryer into the hopper(s) via a first dispenser, providing the second composition of polymer pellets from the second dryer into the hopper(s) atop the first composition of polymer pellets via a second dispenser, and printing and depositing, via the printer nozzle, the melted first composition of polymer pellets and then subsequently printing and depositing, via the printer nozzle, the melted second composition of polymer pellets.

In another embodiment, providing the first and second compositions of polymer pellets from the first and second dryers into the hopper(s), respectively, may include moving the hopper(s) below the first dispenser of the first dryer and dispensing the first composition of polymer pellets from the first dryer via the first dispenser and subsequently moving the hopper(s) from below the first dispenser of the first dryer to below the second dispenser of the second dryer and dispensing the second composition of polymer pellets from the second dryer

In further embodiments, the method may include, when printing and depositing is complete, moving the printer head of at least one print head assembly to a collection area and dispensing extra material from the printer head into the collection area. In certain embodiments, the method may include reusing the extra material.

In yet another embodiment, the method may include measuring, via at least one measuring device, at least one of an amount of the dried plurality of pellets dispensed by the dispenser or an amount of the dried plurality of pellets remaining in the hopper(s). Moreover, in an embodiment, the method may include automatically dispensing, via the dispenser, the dried plurality of pellets into the hopper(s) based on the amount of the dried plurality of pellets remaining in the hopper, the amount of the dried plurality of pellets dispensed by the dispenser, or the amount of the dried plurality of pellets required to form the article.

In additional embodiments, the method may include dispensing, via the dispenser of the drying assembly, the dried plurality of pellets to a plurality of hoppers of a plurality of print head assemblies and moving the plurality of hoppers of the plurality of print head assemblies below the dispenser of the drying assembly or vice versa so as to fill the plurality of hoppers via the dispenser.

It should be understood that the method may further include any of the additional steps and/or features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one embodiment of a rotor blade of a wind turbine according to the present disclosure;

FIG. 3 illustrates an exploded view of the modular rotor blade of FIG. 2;

FIG. 4 illustrates a cross-sectional view of one embodiment of a leading edge segment of a modular rotor blade according to the present disclosure;

FIG. 5 illustrates a cross-sectional view of one embodiment of a trailing edge segment of a modular rotor blade according to the present disclosure;

FIG. 6 illustrates a cross-sectional view of the modular rotor blade of FIG. 2 according to the present disclosure;

FIG. 7 illustrates a cross-sectional view of the modular rotor blade of FIG. 2 according to the present disclosure;

FIG. 8 illustrates a perspective view of one embodiment of a plurality of print head assemblies of a system of forming an article according to the present disclosure;

FIG. 9 illustrates a schematic diagram of one embodiment of a system of forming an article according to the present disclosure;

FIG. 10 illustrates a schematic diagram of another embodiment of a system of forming an article according to the present disclosure;

FIG. 11 illustrates a block diagram of one embodiment of a controller of a system of forming an article according to the present disclosure; and

FIG. 12 illustrates a flow diagram of one embodiment of a method of forming an article according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a system for drying and dispensing polymer pellets into a plurality of hoppers of a 3-D printing apparatus before or during printing. The system includes a drying assembly having at least one dryer for drying the plurality of pellets. Before printing or when printing begins, a dispenser of the dryer dispenses the pellets to one or more hoppers of the 3-D printing apparatus (e.g. either by a metered flow or by dispensing until the pellets reach a mark on the hopper(s)). In certain instances, the dispenser can travel to multiple printer heads and fill each of their respective hoppers with the pellets when printing begins. The printer of the 3-D printing apparatus then melts the pellets and prints the melted material to form an article, such as a rotor blade component. As such, the pellets do not have the opportunity to absorb a significant amount of water. In addition, the system can be automated so as to not require manual transportation of the pellets from the dryer to the 3-D printing apparatus.

3-D printing, as used herein, is generally understood to encompass processes used to synthesize three-dimensional objects in which successive layers of material are formed under computer control to create the objects. As such, objects of almost any size and/or shape can be produced from digital model data. It should further be understood that the methods of the present disclosure are not limited to 3-D printing, but rather, may also encompass more than three degrees of freedom such that the printing techniques are not limited to printing stacked two-dimensional layers, but are also capable of printing curved shapes.

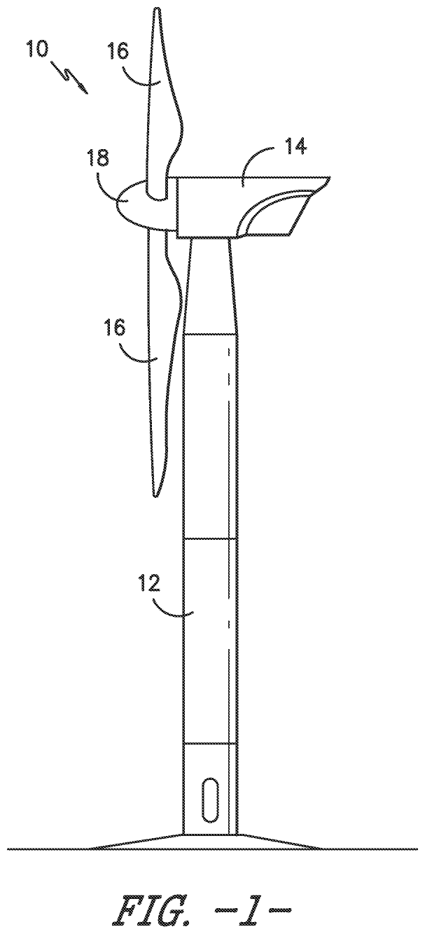

Referring now to the drawings, FIG. 1 illustrates one embodiment of a wind turbine 10 according to the present disclosure. As shown, the wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration. In addition, the present invention is not limited to use with wind turbines, but may be utilized in any application using resin materials. Further, the methods described herein may also apply to manufacturing any similar structure that benefits from the resin formulations described herein.

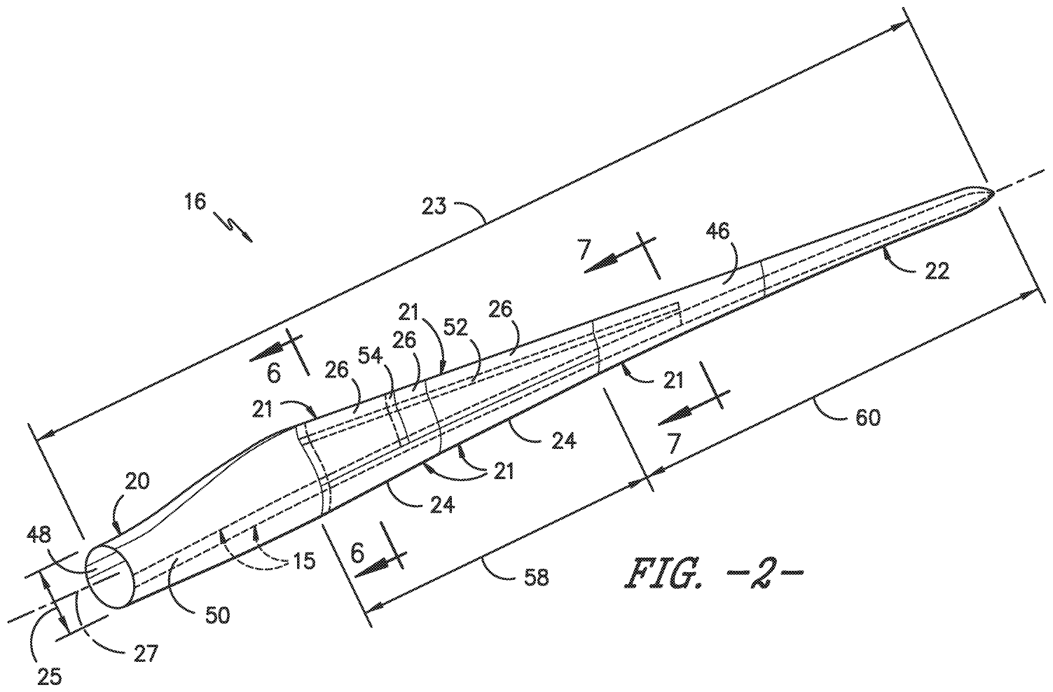

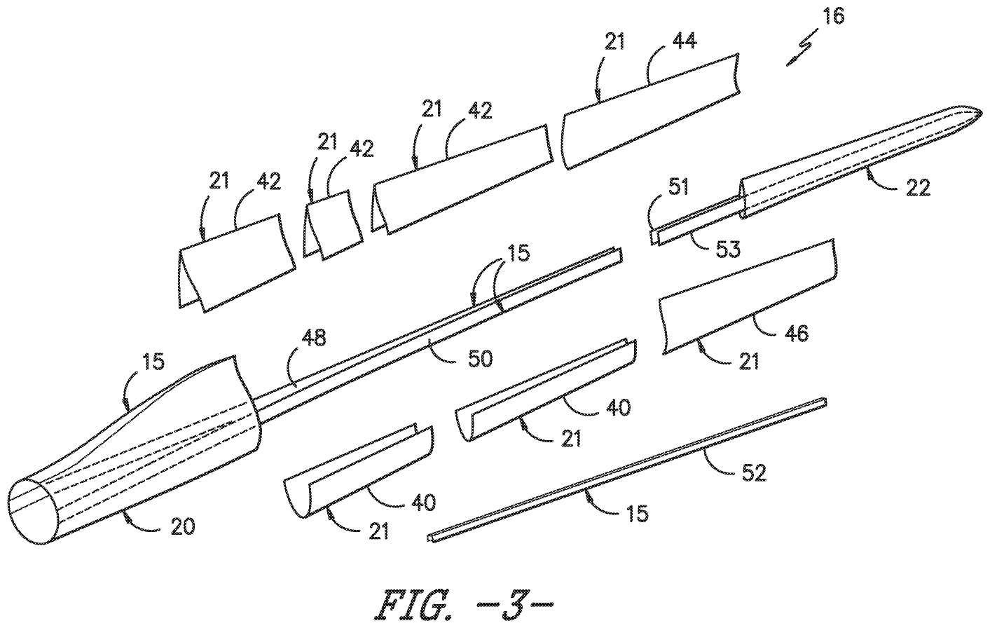

Referring now to FIGS. 2 and 3, various views of a rotor blade 16 according to the present disclosure are illustrated. As shown, the illustrated rotor blade 16 has a segmented or modular configuration. It should also be understood that the rotor blade 16 may include any other suitable configuration now known or later developed in the art. As shown, the modular rotor blade 16 includes a main blade structure 15 and at least one blade segment 21 secured to the main blade structure 15. More specifically, as shown, the rotor blade 16 includes a plurality of blade segments 21.

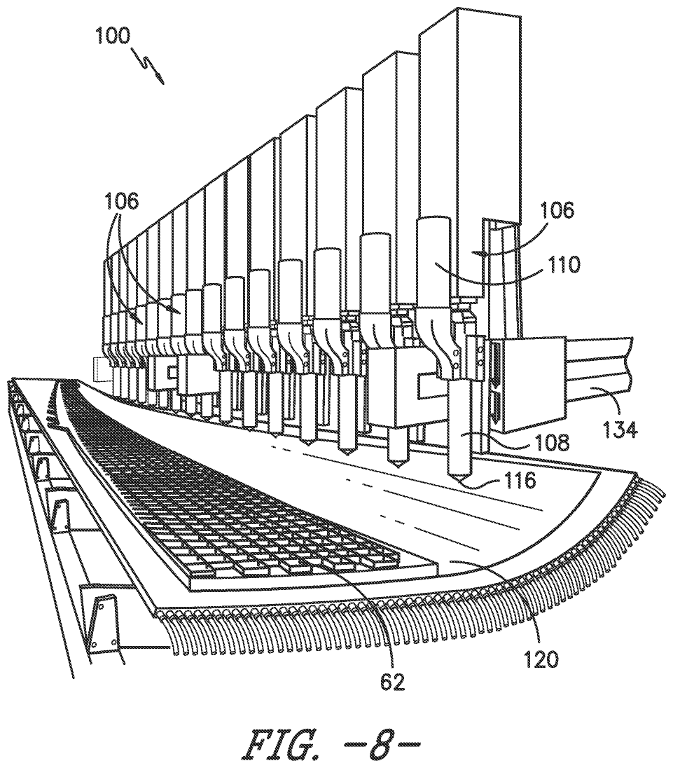

More specifically, as shown, the main blade structure 15 may include any one of or a combination of the following: a pre-formed blade root section 20, a pre-formed blade tip section 22, one or more one or more continuous spar caps 48, 50, 51, 53, one or more shear webs 35 (FIGS. 6-7), an additional structural component 52 secured to the blade root section 20, and/or any other suitable structural component of the rotor blade 16. Further, the blade root section 20 is configured to be mounted or otherwise secured to the rotor 18 (FIG. 1). In addition, as shown in FIG. 2, the rotor blade 16 defines a span 23 that is equal to the total length between the blade root section 20 and the blade tip section 22. As shown in FIGS. 2 and 6, the rotor blade 16 also defines a chord 25 that is equal to the total length between a leading edge 24 of the rotor blade 16 and a trailing edge 26 of the rotor blade 16. As is generally understood, the chord 25 may generally vary in length with respect to the span 23 as the rotor blade 16 extends from the blade root section 20 to the blade tip section 22.

Referring particularly to FIGS. 2-4, any number of blade segments 21 or panels (also referred to herein as blade shells) having any suitable size and/or shape may be generally arranged between the blade root section 20 and the blade tip section 22 along a longitudinal axis 27 in a generally span-wise direction. Thus, the blade segments 21 generally serve as the outer casing/covering of the rotor blade 16 and may define a substantially aerodynamic profile, such as by defining a symmetrical or cambered airfoil-shaped cross-section.

In additional embodiments, it should be understood that the blade segment portion of the blade 16 may include any combination of the segments described herein and are not limited to the embodiment as depicted. More specifically, in certain embodiments, the blade segments 21 may include any one of or combination of the following: pressure and/or suction side segments 44, 46, (FIGS. 2 and 3), leading and/or trailing edge segments 40, 42 (FIGS. 2-6), a non-jointed segment, a single-jointed segment, a multi jointed blade segment, a J-shaped blade segment, or similar.

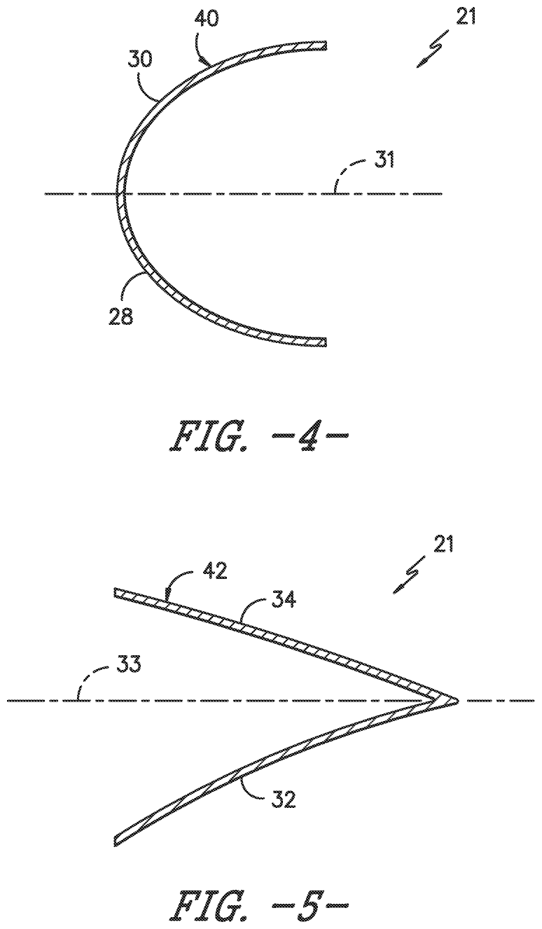

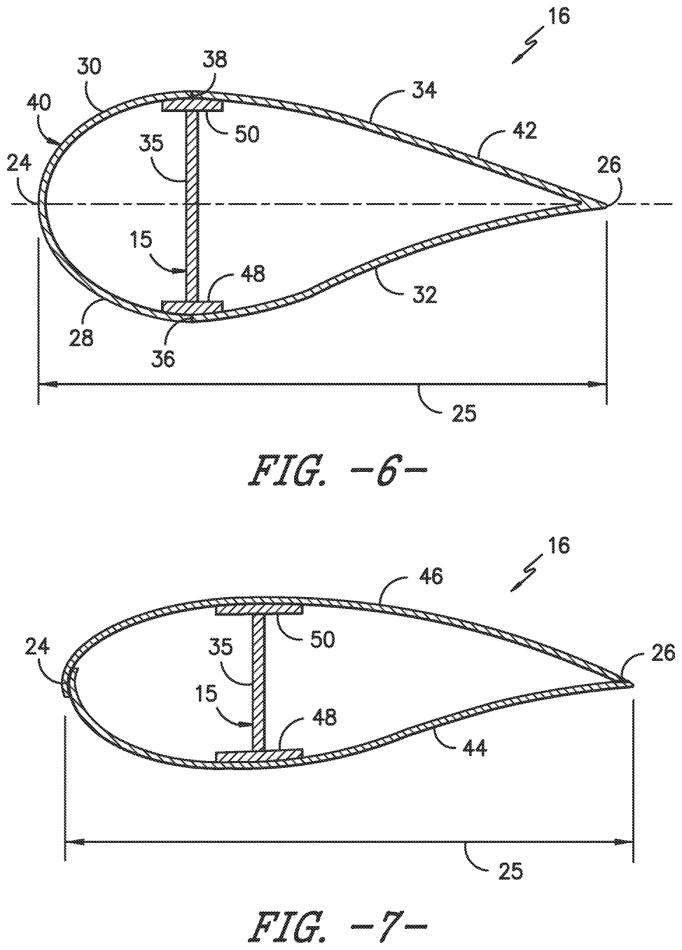

More specifically, as shown in FIG. 4, the leading edge segments 40 may have a forward pressure side surface 28 and a forward suction side surface 30. Similarly, as shown in FIG. 5, each of the trailing edge segments 42 may have an aft pressure side surface 32 and an aft suction side surface 34. Thus, the forward pressure side surface 28 of the leading edge segment 40 and the aft pressure side surface 32 of the trailing edge segment 42 generally define a pressure side surface of the rotor blade 16. Similarly, the forward suction side surface 30 of the leading edge segment 40 and the aft suction side surface 34 of the trailing edge segment 42 generally define a suction side surface of the rotor blade 16. In addition, as particularly shown in FIG. 6, the leading edge segment(s) 40 and the trailing edge segment(s) 42 may be joined at a pressure side seam 36 and a suction side seam 38. For example, the blade segments 40, 42 may be configured to overlap at the pressure side seam 36 and/or the suction side seam 38. Further, as shown in FIG. 2, adjacent blade segments 21 may be configured to overlap at a seam 54. Alternatively, in certain embodiments, the various segments of the rotor blade 16 may be secured together via an adhesive (or mechanical fasteners) configured between the overlapping leading and trailing edge segments 40, 42 and/or the overlapping adjacent leading or trailing edge segments 40, 42.

In specific embodiments, as shown in FIGS. 2-3, the blade root section 20 may include one or more longitudinally extending spar caps 48, 50 infused therewith. For example, the blade root section 20 may be configured according to U.S. application Ser. No. 14/753,155 filed Jun. 29, 2015 entitled “Blade Root Section for a Modular Rotor Blade and Method of Manufacturing Same” which is incorporated herein by reference in its entirety.

Similarly, the blade tip section 22 may include one or more longitudinally extending spar caps 51, 53 infused therewith. More specifically, as shown, the spar caps 48, 50, 51, 53 may be configured to be engaged against opposing inner surfaces of the blade segments 21 of the rotor blade 16. Further, the blade root spar caps 48, 50 may be configured to align with the blade tip spar caps 51, 53. Thus, the spar caps 48, 50, 51, 53 may generally be designed to control the bending stresses and/or other loads acting on the rotor blade 16 in a generally span-wise direction (a direction parallel to the span 23 of the rotor blade 16) during operation of a wind turbine 10. In addition, the spar caps 48, 50, 51, 53 may be designed to withstand the span-wise compression occurring during operation of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

Referring to FIGS. 6-7, one or more shear webs 35 may be configured between the one or more spar caps 48, 50, 51, 53. More particularly, the shear web(s) 35 may be configured to increase the rigidity in the blade root section 20 and/or the blade tip section 22. Further, the shear web(s) 35 may be configured to close out the blade root section 20.

In addition, as shown in FIGS. 2 and 3, the additional structural component 52 may be secured to the blade root section 20 and extend in a generally span-wise direction so as to provide further support to the rotor blade 16. For example, the structural component 52 may be configured according to U.S. application Ser. No. 14/753,150 filed Jun. 29, 2015 entitled “Structural Component for a Modular Rotor Blade” which is incorporated herein by reference in its entirety. More specifically, the structural component 52 may extend any suitable distance between the blade root section 20 and the blade tip section 22. Thus, the structural component 52 is configured to provide additional structural support for the rotor blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 40, 42 can be mounted thereto.

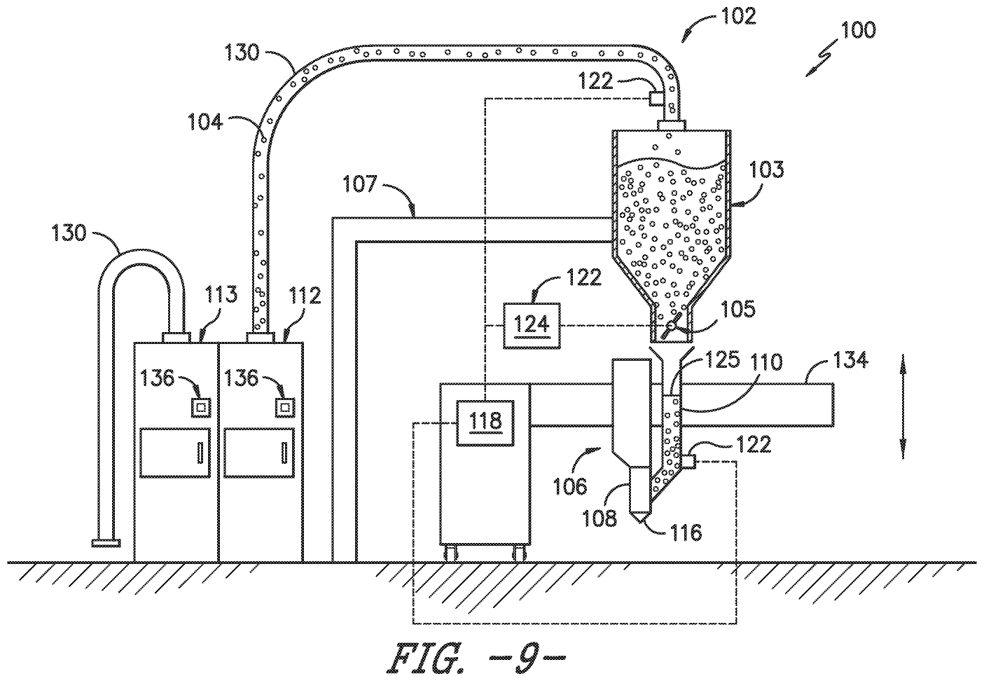

Referring now to FIGS. 8-12, the present disclosure is directed to systems and methods for forming polymer articles, such as any of the rotor blade components described herein, using additive manufacturing with improved drying and dispensing of the polymer pellets into a plurality of hoppers of a 3-D printing apparatus before or during printing. . More specifically, FIGS. 8-10 illustrate various views of one embodiment of an automated computer numeric control (CNC) system 100, such as a 3-D printer, for forming an article according to the present disclosure. As such, in certain embodiments, the article may include a rotor blade shell (a pressure side shell, a suction side shell, a trailing edge segment, a leading edge segment, a grid structure, etc.), a spar cap, a shear web, a blade tip, a blade root, or any other rotor blade component.

Referring specifically to FIG. 8, in an embodiment, the system 100 may include a plurality of print head assemblies 106, e.g. aligned in a row. Further, as shown, each of the print head assemblies 106 includes a hopper 110 in fluid communication with a printer head 108 and a printer nozzle 116. More specifically, as shown, the plurality of print head assemblies 106 may be mounted or otherwise secured to a movable gantry 134. For example, in one embodiment, the moveable gantry 134 may be moveable via a rail system. Thus, the gantry 134 has significant travel ability in one or more directions, such as the y-direction.

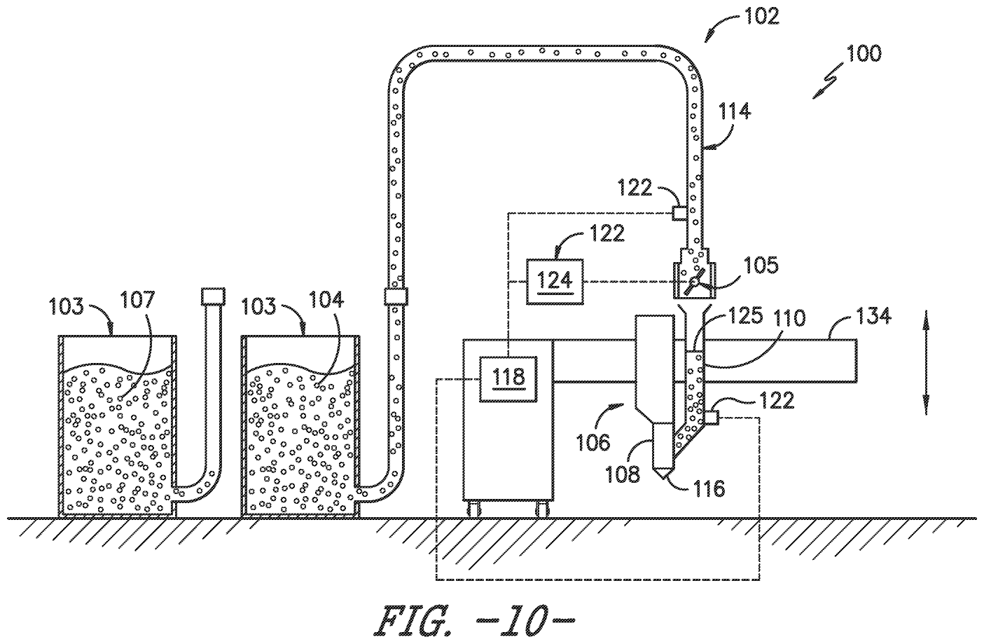

In addition, as shown in FIG. 9, the system 100 may also include a drying assembly 102 having one or more dryers 103 for drying a plurality of polymer pellets 104 of one or more polymer resin formulations that can be used by the print head assemblies 106 to form an article. More specifically, as shown, each of the dryers 103 includes a dispenser 105 for dispensing the dried pellets directly from the dryer(s) 103 and into the hoppers 110. More specifically, as shown, the dispenser(s) 105 of the dryer(s) 102 are positioned above and separate from the hoppers 110 of the print head assemblies 106. Thus, the gantry 134 has significant travel ability in one or more directions, such as the y-direction, to allow the print head assemblies 106 (and their respective hoppers 110) to be moved close to and below the location of the dispenser(s) 105 of the dryer(s) 103 of the drying assembly 102. Alternatively, the drying assembly 102 may be moveable and the hoppers 110 of the print head assemblies 106 may be stationary.

Thus, as shown in FIG. 9, one of the hoppers 110 of the print head assemblies 106 may be moved below the dispenser 105 of the drying assembly 102 and filled with the polymer pellets 104. More specifically, in an embodiment, the gantry 134 may be configured to index one of the hoppers 110 under the dispenser 105 by moving the hopper 110 up or down. Once a first hopper 110 is filled, the gantry 134 can be moved until another hopper is below the dispenser 105. The polymer pellets 104 can then be depositing from the dispenser 105 into the second hopper and so on until all hoppers 110 are filled.

Still referring to FIG. 9, the dispenser 105 of the dryer(s) 103 may be a manual or automatic dispenser for directly dispensing the pellets 104 from the dryer(s) 103 into the individual hoppers 110 before the printing begins. For example, in one embodiment, as shown in FIG. 9, the dispenser 105 may be a valve positioned within an opening of the dryer 103. In such embodiments, the dryer 103 may be mounted to a frame structure 107 such that the dispenser 105 is positioned above and separate from the hoppers 110 of the print head assemblies 106. In addition, as shown, the dryer(s) 103 may be automatically supplied with one or more types of pellets 104 from one or more storage containers 112, 113 connected to the dryer(s) 103 via tubing 130. In such embodiments, the dispenser 105 may be communicatively coupled to a button 136, e.g. on the dryer(s) 103, for controlling the amount of the pellets 104 dispensed by the dispenser 105 and into each of the hoppers 110. Alternatively, an operator may manually supply the dryer(s) 103 with one or more types of pellets 104.

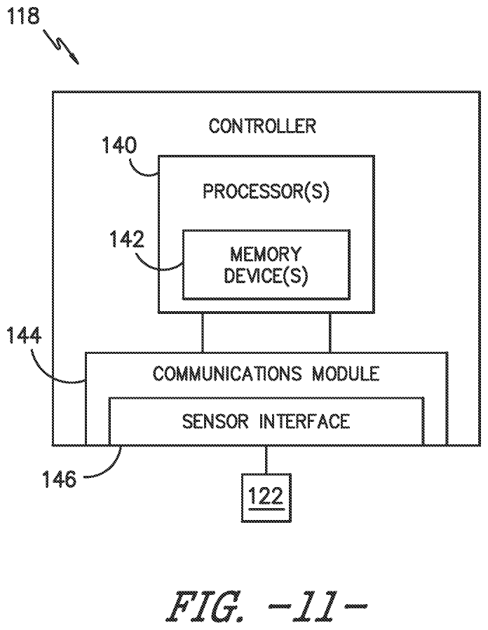

In still alternative embodiments, as shown in FIG. 10, the dispenser 105 may be a flexible hose 114 rather than a valve. In such embodiments, as shown, the flexible hose 114 may be coupled to one or more dryers 103, e.g. at or near a bottom surface thereof, such that the pellets 104, 107 can be easily transported from the dryers 103 to the hoppers 110. More specifically, as shown, the dispenser 105 of flexible hose 114 may be positioned above and separate from the hoppers 110 of the print head assemblies 106 such that the hoppers 110 can be easily filled with the pellets 104.

As such, the pellets 104, 107 dispensed into the hoppers 110 can be used for printing before additional water can be absorbed thereby. In such embodiments, the dispenser 105 is configured to provide a supply of the pellets 104 to the individual hoppers 110 of the print head assemblies 106.

Referring still to FIGS. 9 and 10, the drying assembly 102 may further include any number of dryers 103 and/or additional storage containers 112, 113 for storing a variety of types of polymer pellets. As such, the dryer(s) 103 described herein may be filled with one or more types of polymer pellets 104, 107 to form any suitable polymer resin formulation needed to form the article. Thus, a variety of types of polymer pellets may be used and may include thermoplastic and/or thermoplastic fiber-reinforced pellets as well as blends thereof

The thermoplastic materials as described herein generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material.

Referring still to FIGS. 8 and 9, once dispensed by the dispenser 105, the printer head(s) 108 is configured to melt the dried polymer pellets 104. In addition, the individual printer nozzles 116 are configured to print and deposit the melted polymer pellets 104 to form the article either independently or simultaneously with adjacent printer nozzles 116. Accordingly, the print head assemblies 106 are configured for printing the article, e.g. onto a substrate 120. For example, in certain embodiments, the substrate 120 may correspond to a two-dimensional or flat surface or a three-dimensional surface, such as a curved rotor blade mold. Further, the substrate 120 may simply be a print surface or may ultimately become part of the final article. Thus, as shown in FIG. 8, in an embodiment, the printer nozzles 116 may be configured to print a reinforcement grid structure 62 atop one or more skin layers 56 on the rotor blade mold 120, in which case, the substrate 120 corresponds to the skins which become part of the rotor blade 16. Alternatively, the substrate 120 may simply be a support surface for printing the article thereon and then subsequently removed therefrom.

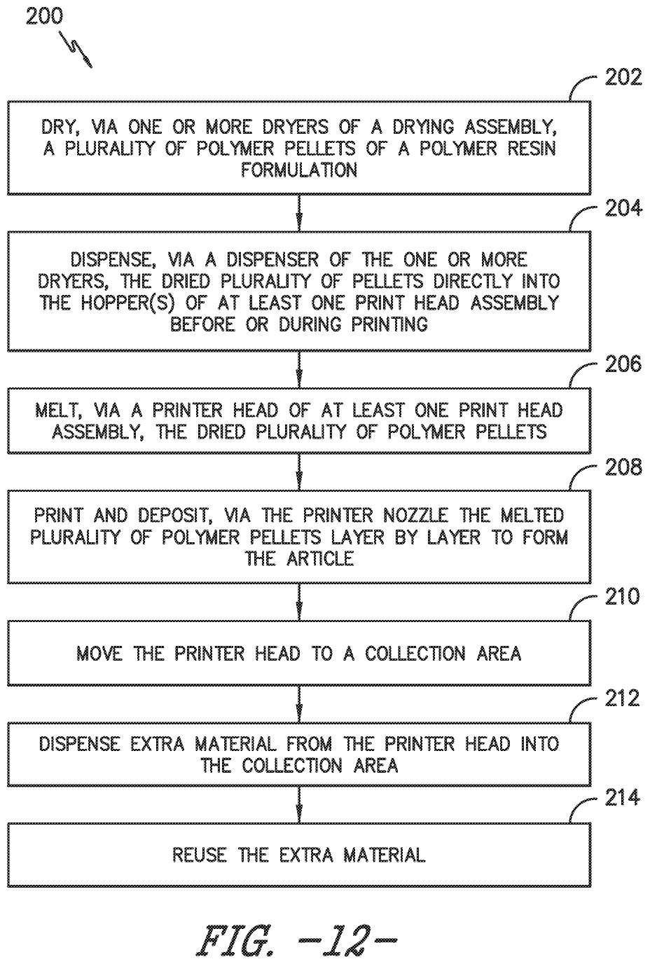

Referring to FIGS. 9 and 11, the system 100 may further include a controller 118 for controlling and automating the system 100. In addition, in an embodiment, as shown, the system 100 may also include one or more measuring devices 122 optionally communicatively coupled to the controller 118. As such, the measuring device(s) 122 may be used for measuring an amount of the dried pellets 104 dispensed by the dispenser 105 and/or an amount of the dried pellets 104 remaining in one or more of the hoppers 110. For example, in one embodiment, the measuring device 122 may be a flow meter 124, a measuring marker 125 on the hopper 110, or any other suitable sensor or measuring feature. Accordingly, in such embodiments, the controller 118 can monitor the amount of the pellets 104 remaining in the hopper(s) 110, the dryer(s) 103, etc., e.g. using measurement signals from the measuring device 122, and can command the dispenser 105 when to dispense more or less of the dried pellets 104 to the hoppers 110 and/or to retrieve more pellets from the storage containers 112, 113.

Referring now to FIG. 11, there is illustrated a block diagram of one embodiment of various components of the controller 118 according to the present disclosure. As shown, the controller 118 may include one or more processor(s) 140 and associated memory device(s) 142 configured to perform a variety of computer-implemented functions (e.g., performing the methods, steps, calculations and the like and storing relevant data as disclosed herein). Additionally, the controller 118 may also include a communications module 144 to facilitate communications between the controller 118 and the various components of the wind turbine 10. Further, the communications module 144 may include a sensor interface 146 (e.g., one or more analog-to-digital converters) to permit signals transmitted from the measuring device(s) 122 to be converted into signals that can be understood and processed by the processors 140. It should be appreciated that the measuring device(s) 122 may be communicatively coupled to the communications module 144 using any suitable means. For example, as shown in FIG. 11, the measuring device(s) 122 are coupled to the sensor interface 64 via a wired connection. However, in other embodiments, the measuring device(s) 122 may be coupled to the sensor interface 146 via a wireless connection, such as by using any suitable wireless communications protocol known in the art.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 142 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 142 may generally be configured to store suitable computer-readable instructions that, when implemented by the processor(s) 140, configure the controller 118 to perform the various functions described herein.

Referring now to FIG. 12, a flow diagram of one embodiment of a method 200 for forming an article according to the present disclosure. In general, the method 200 is described herein as implemented for manufacturing the rotor blade components described above. However, it should be appreciated that the disclosed method 200 may be used to manufacture any other rotor blade components as well as any other articles. In addition, although FIG. 12 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (202), the method 200 includes drying, via one or more dryers 103 of the drying assembly 102, the plurality of polymer pellets of one or more polymer resin formulations. As shown at (204), the method 200 includes dispensing, via the dispenser 105, the dried plurality of pellets directly into the hopper(s) 110 of the print head assembly 106 before or during printing. Further, as mentioned, the dispenser 105 is positioned above and separate from the hopper(s) 110.

In another embodiment, the method 200 may include determining an amount of the plurality of polymer pellets required to build the article and providing the amount to the hopper(s) 110 via the dispenser 105. For example, in one embodiment, determining the amount of the plurality of polymer pellets required to build the article may include providing an additional margin of the dried plurality of polymer pellets above what is required to build the article.

In further embodiments, the plurality of polymer pellets may include, at least, a first composition of polymer pellets 104 in a first dryer 103 and a different, second composition of polymer pellets 107 in a second dryer 103 (e.g. as shown in FIG. 10). Further, the first and second compositions of polymer pellets may each include any one or more polymer types and/or compositions or combinations thereof that may also optionally include fiber reinforcement, UV stabilizers, color concentrates, other additives, etc. The multiple materials 104, 107 can then be dispensed into the hopper(s) 110 of the printer head 108 via one or more dispensers 105. In such embodiments, the printer head 108 can melt and print the first composition of polymer pellets 104 in the first layer (or first few layers), e.g. to promote better bonding to a substrate surface, and can then transition to the second composition of polymer pellets 107, which, in certain embodiments, may be a blend of polymers. As such, the printer head 108 is configured to print any desired article using any combination of materials.

In another embodiment, providing the first and second compositions of polymer pellets 104, 107 from the first and second dryers into the hopper(s) 110, respectively, may include moving the hopper(s) 110 below the first dispenser 105 of the first dryer 103 and dispensing the first composition of polymer pellets 104 from the first dryer 103 via the first dispenser 105 and subsequently moving the hopper(s) 110 to below the second dispenser of the second dryer 103 and dispensing the second composition of polymer pellets 107 from the second dryer 103.

In yet another embodiment, the method 200 may include measuring, via the measuring device(s) 122, an amount of the dried plurality of pellets 104 dispensed by the dispenser or an amount of the dried plurality of pellets remaining in the hopper(s) 110. For example, in an embodiment, the measuring device(s) 122 are configured to measure the amount of dried polymer pellets 104 required to build the article plus an additional margin of the dried pellets 104 above what is required. Thus, the additional margin is configured to cover an amount of material required for initial priming of the printer and to ensure the printer head 108 does not run out of pellets 104 during printing. By metering an exact amount of material needed to build the article plus the additional margin, material waste is minimized. In addition, there is almost no opportunity for the pellets 104 in to the hopper 110 to absorb a significant amount of moisture. Another benefit is that there would not be significant material degradation in the printer due to process heat after the print cycle is finished as the hopper 110 would be substantially empty, particularly after dispensing any additional remaining material into the collection area after printing is complete.

Referring still to FIG. 12, as shown at (206), the method 200 includes melting, via the printer head 108 print head assembly 106, the dried plurality of polymer pellets. As shown at (208), the method 200 includes printing and depositing, via the printer nozzle 116 of the print head assembly 106, the melted plurality of polymer pellets, e.g. layer by layer, to form the article.

In another embodiment, as shown at (210), (212), and (214), when printing and depositing is complete, the method 200 may also include moving the printer head 108 of the print head assembly 106 to a collection area, dispensing extra material from the printer head 108 into the collection area, and reusing the extra material in subsequent printing processes.

Various aspects and embodiments of the present invention are defined by the following numbered clauses:

Clause 1. A system for forming an article,

at least one print head assembly comprising a printer head, a printer nozzle, and at least one hopper;

a drying assembly comprising at least one dryer and at least one dispenser, the at least one dryer for drying a plurality of polymer pellets of one or more polymer resin formulations, the dispenser positioned above and separate from the hopper of the at least one print head assembly, the dispenser for dispensing the dried plurality of pellets directly from the drying assembly and into the hopper of the at least one print head assembly before or during printing, the printer head configured to melt the dried plurality of polymer pellets, the printer nozzle configured for depositing and printing the melted plurality of polymer pellets onto a substrate to form the article; and

a controller for controlling and automating the system.

Clause 2. The system of Clause 1, further comprising one or more measuring devices communicatively coupled to the controller, the one or more measuring devices for measuring at least one of an amount of the dried plurality of pellets dispensed by the dispenser, or an amount of the dried plurality of pellets remaining in the hopper.

Clause 3. The system of Clause 2, wherein the one or more measuring devices comprise at least one of a sensor or a measuring marker on the hopper.

Clause 4. The system of Clause 2, wherein the controller monitors at least one of the amount of the dried plurality of pellets remaining in the hopper and a duration of time that the dried plurality of pellets have remained in the hopper and commands the dispenser when to dispense more of the dried plurality of pellets into the hopper.

Clause 5. The system of Clause 2, wherein the controller monitors the amount of the dried plurality of pellets remaining in the hopper and if the amount is not reducing during printing, the controller implements a corrective action, the corrective action comprising at least one of generating an error signal, stopping or pausing the depositing and printing, and/or agitating the dried plurality of pellets remaining in the hopper.

Clause 6. The system of Clause 2, wherein the dispenser further comprises at least one of a valve or a hose, the dispenser configured to manually or automatically dispense the dried plurality of pellets into the hopper based on the amount of the dried plurality of pellets remaining in the hopper, the amount of the dried plurality of pellets dispensed by the dispenser, and/or the amount of the dried plurality of pellets required to form the article.

Clause 7. The system of any of the preceding clauses, further comprising a plurality of print head assemblies, wherein the dispenser is configured to separately dispense the dried plurality of pellets directly into a plurality of hoppers of the plurality of print head assemblies.

Clause 8. The system of Clause 7, wherein the dispenser is stationary and the plurality of hoppers of the plurality of print head assemblies are movable so as to fill the plurality of hoppers via the dispenser.

Clause 9. The system of Clause 8, wherein the plurality of hoppers of the plurality of print head assemblies is movable via a moveable gantry secured to a rail system.

Clause 10. A method of forming an article, the method comprising:

drying, via at least one dryer of a drying assembly, a plurality of polymer pellets of one or more polymer resin formulations;

dispensing, via a dispenser of the drying assembly, the dried plurality of pellets directly into at least one hopper of at least one print head assembly before or during printing, the dispenser positioned above and separate from the at least one hopper;

melting, via a printer head of at least one print head assembly, the dried plurality of polymer pellets; and

printing and depositing, via a printer nozzle of at least one print head assembly, the melted plurality of polymer pellets layer by layer to form the article.

Clause 11. The method of Clause 10, further comprising determining an amount of the plurality of polymer pellets required to build the article and providing the amount to the at least one hopper via the dispenser.

Clause 12. The method of Clause 11, wherein determining the amount of the plurality of polymer pellets required to build the article further comprises providing an additional margin of the dried plurality of polymer pellets above what is required to build the article.

Clause 13. The method of Clauses 10-12, wherein the plurality of polymer pellets further comprise, at least, a first composition of polymer pellets in a first dryer and a different, second composition of polymer pellets in a second dryer, the first and second compositions of polymer pellets each comprising one or more polymer types and/or compositions or combinations thereof.

Clause 14. The method of Clause 13, further comprising:

providing the first composition of polymer pellets from the first dryer into the at least one hopper via a first dispenser;

providing the second composition of polymer pellets from the second dryer into the at least one hopper atop the first composition of polymer pellets via a second dispenser; and

printing and depositing, via the printer nozzle, the melted first composition of polymer pellets and printing and depositing, via the printer nozzle, the melted second composition of polymer pellets.

Clause 15. The method of Clause 14, wherein providing the first and second compositions of polymer pellets from the first and second dryers into the at least one hopper, respectively, further comprises:

moving the at least one hopper below the first dispenser of the first dryer and dispensing the first composition of polymer pellets from the first dryer via the first dispenser; and

subsequently moving the at least one hopper from below the first dispenser of the first dryer to below the second dispenser of the second dryer and dispensing the second composition of polymer pellets from the second dryer atop the first composition of polymer pellets via the second dispenser.

Clause 16. The method of Clauses 10-15, further comprising:

when printing and depositing is complete, moving the printer head of at least one print head assembly to a collection area; and

dispensing extra material from the printer head into the collection area.

Clause 17. The method of Clause 16, further comprising reusing the extra material.

Clause 18. The method of Clauses 10-17, further comprising measuring, via at least one measuring device, at least one of an amount of the dried plurality of pellets dispensed by the dispenser or an amount of the dried plurality of pellets remaining in the at least one hopper.

Clause 19. The method of Clause 18, further comprising automatically dispensing, via the dispenser, the dried plurality of pellets into the at least one hopper based on the amount of the dried plurality of pellets remaining in the hopper, the amount of the dried plurality of pellets dispensed by the dispenser, or the amount of the dried plurality of pellets required to form the article.

Clause 20. The method of Clause 19, further comprising:

dispensing, via the dispenser of the at least one drying assembly, the dried plurality of pellets to a plurality of hoppers of a plurality of print head assemblies; and

moving the plurality of hoppers of the plurality of print head assemblies below the dispenser of the at least one drying assembly or vice versa so as to fill the plurality of hoppers via the dispenser.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for forming an article,
at least one print head assembly comprising a printer head, a printer nozzle, and at least one hopper;
a drying assembly comprising at least one dryer and at least one dispenser, the at least one dryer for drying a plurality of polymer pellets of one or more polymer resin formulations, the dispenser positioned above and separate from the hopper of the at least one print head assembly, the dispenser for dispensing the dried plurality of pellets directly from the drying assembly and into the hopper of the at least one print head assembly before or during printing, the printer head configured to melt the dried plurality of polymer pellets, the printer nozzle configured for depositing and printing the melted plurality of polymer pellets onto a substrate to form the article; and
a controller for controlling and automating the system.

2. The system of claim 1, further comprising one or more measuring devices communicatively coupled to the controller, the one or more measuring devices for measuring at least one of an amount of the dried plurality of pellets dispensed by the dispenser, or an amount of the dried plurality of pellets remaining in the hopper.

3. The system of claim 2, wherein the one or more measuring devices comprise at least one of a sensor or a measuring marker on the hopper.

4. The system of claim 2, wherein the controller monitors at least one of the amount of the dried plurality of pellets remaining in the hopper and a duration of time that the dried plurality of pellets have remained in the hopper and commands the dispenser when to dispense more of the dried plurality of pellets into the hopper.

5. The system of claim 2, wherein the controller monitors the amount of the dried plurality of pellets remaining in the hopper and if the amount is not reducing during printing, the controller implements a corrective action, the corrective action comprising at least one of generating an error signal, stopping or pausing the depositing and printing, and/or agitating the dried plurality of pellets remaining in the hopper.

6. The system of claim 2, wherein the dispenser further comprises at least one of a valve or a hose, the dispenser configured to manually or automatically dispense the dried plurality of pellets into the hopper based on the amount of the dried plurality of pellets remaining in the hopper, the amount of the dried plurality of pellets dispensed by the dispenser, and/or the amount of the dried plurality of pellets required to form the article.

7. The system of claim 1, further comprising a plurality of print head assemblies, wherein the dispenser is configured to separately dispense the dried plurality of pellets directly into a plurality of hoppers of the plurality of print head assemblies.

8. The system of claim 7, wherein the dispenser is stationary and the plurality of hoppers of the plurality of print head assemblies are movable so as to fill the plurality of hoppers via the dispenser.

9. The system of claim 8, wherein the plurality of hoppers of the plurality of print head assemblies is movable via a moveable gantry secured to a rail system.

10. A method of forming an article, the method comprising:
drying, via at least one dryer of a drying assembly, a plurality of polymer pellets of one or more polymer resin formulations;
dispensing, via a dispenser of the drying assembly, the dried plurality of pellets directly into at least one hopper of at least one print head assembly before or during printing, the dispenser positioned above and separate from the at least one hopper;
melting, via a printer head of at least one print head assembly, the dried plurality of polymer pellets; and
printing and depositing, via a printer nozzle of at least one print head assembly, the melted plurality of polymer pellets layer by layer to form the article.

11. The method of claim 10, further comprising determining an amount of the plurality of polymer pellets required to build the article and providing the amount to the at least one hopper via the dispenser.

12. The method of claim 11, wherein determining the amount of the plurality of polymer pellets required to build the article further comprises providing an additional margin of the dried plurality of polymer pellets above what is required to build the article.

13. The method of claim 10, wherein the plurality of polymer pellets further comprise, at least, a first composition of polymer pellets in a first dryer and a different, second composition of polymer pellets in a second dryer, the first and second compositions of polymer pellets each comprising one or more polymer types and/or compositions or combinations thereof

14. The method of claim 13, further comprising:
providing the first composition of polymer pellets from the first dryer into the at least one hopper via a first dispenser;
providing the second composition of polymer pellets from the second dryer into the at least one hopper atop the first composition of polymer pellets via a second dispenser; and
printing and depositing, via the printer nozzle, the melted first composition of polymer pellets and printing and depositing, via the printer nozzle, the melted second composition of polymer pellets.

15. The method of claim 14, wherein providing the first and second compositions of polymer pellets from the first and second dryers into the at least one hopper, respectively, further comprises:
moving the at least one hopper below the first dispenser of the first dryer and dispensing the first composition of polymer pellets from the first dryer via the first dispenser; and
subsequently moving the at least one hopper from below the first dispenser of the first dryer to below the second dispenser of the second dryer and dispensing the second composition of polymer pellets from the second dryer atop the first composition of polymer pellets via the second dispenser.

16. The method of claim 10, further comprising:
when printing and depositing is complete, moving the printer head of at least one print head assembly to a collection area; and
dispensing extra material from the printer head into the collection area.

17. The method of claim 16, further comprising reusing the extra material.

18. The method of claim 10, further comprising measuring, via at least one measuring device, at least one of an amount of the dried plurality of pellets dispensed by the dispenser or an amount of the dried plurality of pellets remaining in the at least one hopper.

19. The method of claim 18, further comprising automatically dispensing, via the dispenser, the dried plurality of pellets into the at least one hopper based on the amount of the dried plurality of pellets remaining in the hopper, the amount of the dried plurality of pellets dispensed by the dispenser, or the amount of the dried plurality of pellets required to form the article.

20. The method of claim 19, further comprising:
dispensing, via the dispenser of the at least one drying assembly, the dried plurality of pellets to a plurality of hoppers of a plurality of print head assemblies; and
moving the plurality of hoppers of the plurality of print head assemblies below the dispenser of the at least one drying assembly or vice versa so as to fill the plurality of hoppers via the dispenser.
